(19) United States
(12) Patent Application Publication
(10) Pub. No.: US 2002/0029431 A1
(43) Pub. Date: Mar. 14, 2002

(54) Substrate cleaning apparatus

(76) Inventors: Fumitoshi Oikawa, Kanagawa-ken (JP); Koji Atoh, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 09/918,570

(22) Filed: Aug. 1, 2001

(30) Foreign Application Priority Data
Aug. 1, 2000 (JP) 233251/2000

(51) Int. Cl. B08B 1/04

(52) U.S. Cl. 15/77; 15/88.2; 15/88.3

(57) ABSTRACT

A substrate cleaning apparatus for cleaning a surface of a substrate with a cleaning member brought into contact with the substrate surface while supplying a cleaning liquid to the substrate surface, wherein the apparatus includes a contact pressure adjusting mechanism for adjusting the pressure at which the cleaning member is brought into contact with the substrate surface, and a controller for controlling the contact pressure adjusting mechanism, and the contact pressure can be set and adjusted to a predetermined value from the controller, whereby, it is possible to change the contact pressure according to the state of progress of the cleaning process and to obtain an ultraclean substrate surface.

### BACKGROUND OF THE INVENTION

The present invention relates to an apparatus for cleaning a substrate, e.g. a semiconductor substrate used in the process of manufacturing semiconductor devices.

With the rapid progress of the technology to fabricate high-integration semiconductor devices, circuit wiring patterns have been becoming increasingly small and fine. Consequently, it is demanded that the number of dust particles remaining on a semiconductor wafer be minimized. That is, ultraclean wafer surface preparation is demanded. Conventional substrate cleaning apparatus usable for this purpose include roll-type brush cleaning apparatus and pencil-type brush cleaning apparatus.

As shown in FIG. 1, a roll-type brush cleaning apparatus is a substrate cleaning apparatus 10 including a substrate rotating mechanism having a plurality of (six in the illustrated example) spindles 11. The spindles 11 rotate while holding the outer peripheral portion of a substrate Wf to be cleaned. The substrate cleaning apparatus 10 further includes rotary roll-type cleaning members 12 and 13 driven to rotate by respective driving mechanisms 15 and 16. The rotating cleaning members 12 and 13 are pressed against both sides of the substrate Wf being rotated approximately in the horizontal plane by the substrate rotating mechanism. In addition, a cleaning liquid is supplied onto the surface of the substrate Wf from a cleaning liquid nozzle 14. In this way, the substrate cleaning apparatus 10 cleans the substrate Wf with the rotary roll-type cleaning members 12 and 13 while supplying the cleaning liquid to the surface of the substrate Wf. It should be noted that the cleaning liquid nozzle 14 is provided at each of two positions, that is, above and below the substrate Wf, so that the cleaning liquid can be supplied not only to the upper surface of the substrate Wf but also to the lower surface thereof (although the cleaning liquid nozzle 14 provided below the substrate Wf is not shown in the figure). Further, the outer peripheral portions of the rotary roll-type cleaning members 12 and 13 that are brought into contact with the substrate Wf are made of a porous PVA sponge.

A pencil-type brush cleaning apparatus has, as shown in FIG. 2, a rotary chuck mechanism 31 and a pencil-type brush cleaning mechanism 32. The rotary chuck mechanism 31 has chuck members 33 on the top thereof to hold the outer periphery of a disk-shaped substrate Wf to be cleaned. The chuck members 33 are driven to rotate by a rotatively driving shaft 34. The chuck members 33 of the rotary chuck mechanism 31 are provided with a chuck opening and closing mechanism (not shown in FIG. 2) so that the substrate Wf can be loaded and unloaded with a hand of a robot (not shown).

The pencil-type brush cleaning mechanism 32 has a pivoting arm 36 supported at one end thereof by a shaft 35. The pivoting arm 36 has a rotatively driving shaft 37 at the other end thereof. The rotatively driving shaft 37 projects vertically downward toward the surface of the substrate Wf to be cleaned. A pencil-type cleaning member 38 is secured to the lower end of the rotatively driving shaft 37. The pencil-type cleaning member 38 is made of a porous PVA sponge. The upper surface of the rotating substrate Wf is supplied with a cleaning liquid from a cleaning liquid nozzle 39, and at the same time, the rotating pencil-type cleaning member 38 is brought into contact with the surface of the substrate Wf, thereby cleaning the substrate surface.

In the above-described roll-type brush cleaning apparatus and pencil-type brush cleaning apparatus, the capability of removing particles from the surface of the substrate Wf depends on the pressure with which the rotary roll-type cleaning members 12 and 13 or the pencil-type cleaning member 38 is pressed against the surface of the substrate Wf. In addition, an excessive contact pressure may cause damage to the patterns formed on the substrate Wf. Accordingly, it is important to control and adjust the contact pressure with which the rotary roll-type cleaning members 12 and 13 or the pencil-type cleaning member 38 are brought into contact with the substrate Wf at all times during the cleaning process. Conventional substrate cleaning apparatus are not adapted to adjust the contact pressure as desired from a controller or to change the contact pressure during cleaning process according to the state of progress of the cleaning process, although some of the conventional apparatus are arranged to effect control so that the contact pressure is kept within a set range. Accordingly, the conventional substrate cleaning apparatus cannot satisfactorily attain the above-described ultrahigh cleanliness required for semiconductor substrates.

### SUMMARY OF THE INVENTION

The present invention was made in view of the above-described circumstances.

Accordingly, an object of the present invention is to provide a substrate cleaning apparatus that allows the contact pressure to be set and adjusted as desired by a simple operation from a controller during the cleaning process with a simple arrangement, and that is capable of cleaning a substrate while maintaining the set and adjusted contact pressure and also capable of changing the contact pressure according to the condition of progress of the cleaning process and hence capable of obtaining an ultraclean substrate surface.

To attain the above-described object, the present invention provides a substrate cleaning apparatus arranged to clean a surface of a substrate with a cleaning member brought into contact with the substrate surface while supplying a cleaning liquid to the substrate surface. The apparatus includes a contact pressure adjusting mechanism for adjusting the pressure with which the cleaning member is brought into contact with the substrate surface. The apparatus further includes a controller for controlling the contact pressure adjusting mechanism. With the substrate cleaning apparatus, the contact pressure can be set and adjusted to a predetermined value from the controller.

As stated above, the substrate cleaning apparatus allows the contact pressure to be set and adjusted as desired by controlling the contact pressure adjusting mechanism from the controller. Therefore, the contact pressure can readily be set and adjusted to a pressure suitable for ultraclean substrate surface preparation. Thus, it is possible to obtain an ultraclean substrate surface.

Preferably, the substrate cleaning apparatus further includes a contact pressure sensor for detecting the contact pressure.

The provision of the contact pressure sensor allows the contact pressure to be set and adjusted from the controller while monitoring the actual contact pressure with the contact pressure sensor.

Preferably, the substrate cleaning apparatus further includes a controller for comparing the contact pressure value set on the controller with the contact pressure value detected with the contact pressure sensor and for effecting control so that the difference between the contact pressure values becomes zero.

If the substrate cleaning apparatus is provided with the controller that compares the contact pressure value set on the controller with the contact pressure value detected with the contact pressure sensor and effects control so that the difference between the contact pressure values becomes zero, the actual contact pressure can be made to accurately follow the contact pressure set and adjusted on the controller. Accordingly, it becomes possible to obtain an ultraclean substrate surface.

Preferably, the controller allows the contact pressure to be changed according to the state of progress of the cleaning of the substrate.

To obtain an ultraclean substrate surface, the contact pressure with which the cleaning member is brought into contact with the substrate surface should not be left constant throughout the cleaning process. In order to smoothly perform ultraclean substrate surface preparation it is necessary to change the contact pressure according to the state of progress of cleaning (e.g. the contact pressure is set low at the beginning of the cleaning process and increased as the cleaning process progresses, and when the cleaning process is close to an end, the contact pressure is decreased). Because the controller allows the contact pressure to be changed according to the state of progress of cleaning of the substrate, it is possible to comply with the above-described demand.

In the foregoing substrate cleaning apparatus, the contact pressure sensor may be a pressure sensor for detecting the contact pressure by detecting stress applied to a cleaning member supporting arm for supporting the cleaning member.

If the contact pressure sensor is a pressure sensor (e.g. a load cell) for detecting stress applied to the cleaning member supporting arm, the pressure sensor can be mounted on a predetermined portion of the cleaning member supporting arm of the substrate cleaning apparatus where the pressure sensor will not be contaminated with the cleaning liquid or the like. Accordingly, the contact pressure can be detected with high accuracy, and mounting of the pressure sensor is facilitated.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a diagram showing a structural example of a roll-type brush cleaning apparatus

FIG. 2 is a diagram showing a structural example of a pencil-type brush cleaning apparatus.

FIG. 3 is a diagram showing the arrangement of a contact pressure adjusting mechanism and a control system therefor in a substrate cleaning apparatus according to an embodiment of the present invention.

FIG. 4 is a diagram showing the arrangement of a contact pressure adjusting mechanism and a control system therefor in a substrate cleaning apparatus according to another embodiment of the present invention.

### DETAILED DESCRIPTION OF THE INVENTION

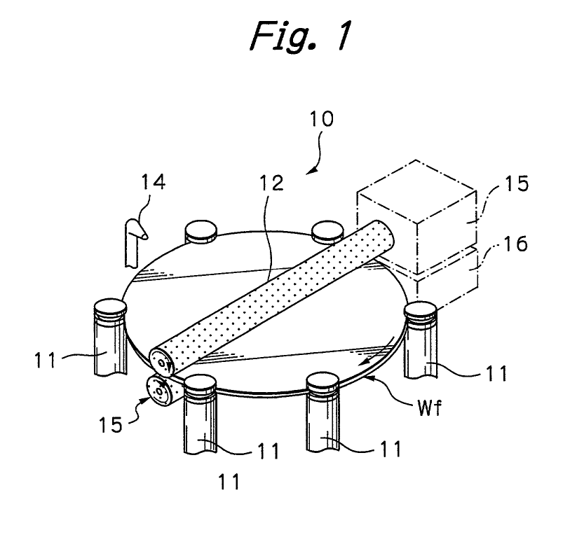

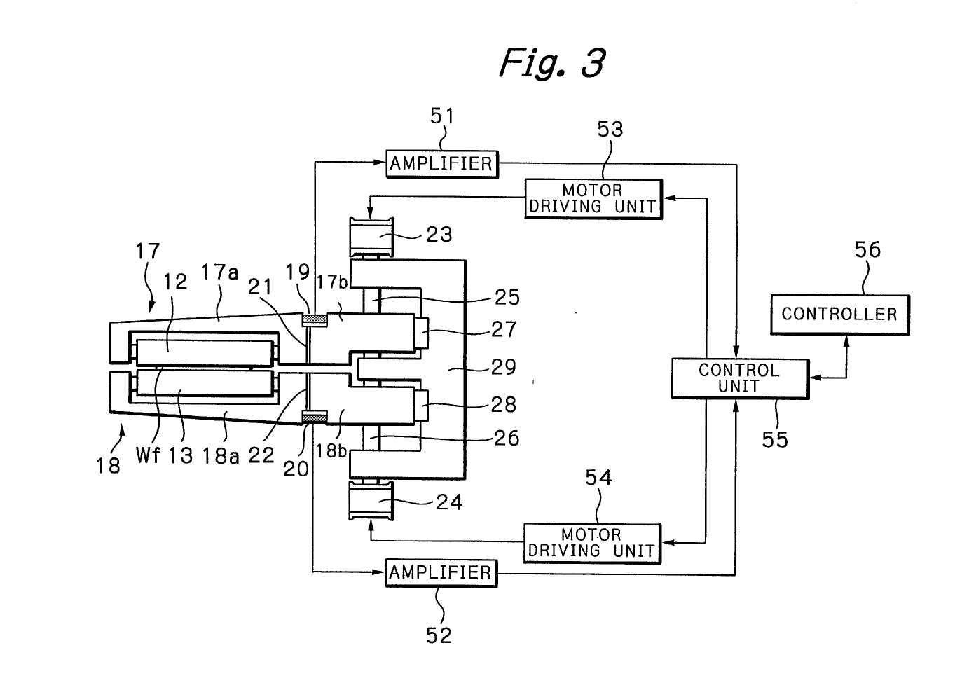

Embodiments of the present invention will be described below in detail with reference to the accompanying drawings. FIG. 3 shows the arrangement of a contact pressure adjusting mechanism and a control system therefor in a substrate cleaning apparatus according to an embodiment of the present invention. The arrangement of the substrate cleaning apparatus using the contact pressure adjusting mechanism and the control system is substantially the same as the arrangement shown in FIG. 1. Therefore, a description of the arrangement is omitted. In FIG. 3, reference numeral 17 denotes a cleaning member supporting arm for rotatably supporting the rotary roll-type cleaning member 12 shown in FIG. 1. Reference numeral 18 denotes a cleaning member supporting arm for rotatably supporting the rotary roll-type cleaning member 13 shown in FIG. 1.

The cleaning member supporting arm 17 is in thread engagement with a ball screw 25. The arm 17 is vertically movable in response to the rotation of the ball screw 25. The cleaning member supporting arm 18 is in thread engagement with a ball screw 26. The arm 18 is vertically movable in response to the rotation of the ball screw 26. The ball screw 25 is driven to rotate by a motor 23. The ball screw 26 is driven to rotate by a motor 24. A linear guide 27 is provided at the rear end of the cleaning member supporting arm 17 to guide the arm 17. A linear guide 28 is provided at the rear end of the cleaning member supporting arm 18 to guide the arm 18.

The linear guides 27 and 28 are vertically movable along a bracket 29 independently of each other. The ball screws 25 and 26 are rotatably supported by the bracket 29. The cleaning member supporting arm 17 comprises a front member 17a and a rear member 17b. A buffer damper 21 is interposed between the front member 17a and the rear member 17b. The rotary roll-type cleaning member 12 is rotatably supported by the front member 17a. The cleaning member supporting arm 18 comprises a front member 18a and a rear member 18b. A buffer damper 22 is interposed between the front member 18a and the rear member 18b. The rotary roll-type cleaning member 13 is rotatably supported by the front member 18a.

A load cell 19 is provided between the front member 17a and the rear member 17b of the cleaning member supporting arm 17. The load cell 19 can detect stress applied to the cleaning member supporting arm 17. That is, when the rotary roll-type cleaning member 12 presses the substrate Wf, the front member 17a of the cleaning member supporting arm 17 is subjected to reaction force such that the front member 17a pivots upward through the buffer damper 21. Consequently, the load cell 19 receives compressive force corresponding to the reaction force from the front member 17a and the rear member 17b. Thus, the load cell 19 can accurately detect the contact pressure with which the rotary roll-type cleaning member 12 is brought into contact with the substrate Wf.

Similarly, a load cell 20 is provided between the front member 18a and the rear member 18b of the cleaning member supporting arm 18. The load cell 20 can detect stress applied to the cleaning member supporting arm 18. That is, when the rotary roll-type cleaning member 13 presses the substrate Wf, the front member 18a of the cleaning member supporting arm 18 is subjected to reaction force such that the front member 18a pivots downward through the buffer damper 22. Consequently, the load cell 20 receives compressive force corresponding to the reaction force from the front member 18a and the rear member 18b. Thus, the load cell 20 can accurately detect the contact pressure with which the rotary roll-type cleaning member 13 is brought into contact with the substrate Wf.

The output signals from the load cells 19 and 20 are amplified in amplifiers 51 and 52, respectively, and then transmitted to a control unit 55. The control unit 55 is connected with a controller 56. The controller 56 is formed from a touch panel or the like, which is arranged to allow setting and adjustment of the contact pressures at which the rotary roll-type cleaning members 12 and 13 are brought into contact with the substrate Wf. When the contact pressures of the rotary roll-type cleaning members 12 and 13 are set on the controller 56, the control unit 55 drives the motors 23 and 24 through motor driving units 53 and 54 on the basis of the set values. This causes the ball screws 25 and 26 to rotate. Consequently, the cleaning member supporting arm 17 moves downward, and the cleaning member supporting arm 18 moves upward, causing the rotary roll-type cleaning members 12 and 13 to come into contact with the substrate Wf at the set contact pressures.

The contact pressures of the rotary roll-type cleaning members 12 and 13 are detected with the load cells 19 and 20. The detected signals are amplified in the amplifiers 51 and 52, respectively, and then transmitted to the control unit 55. The control unit 55 compares the detected contact pressure values with the contact pressure values set on the controller 56 and drives the motors 23 and 24 through the motor driving units 53 and 54 so that the differences between the detected and set contact pressure values become zero or a predetermined range. Consequently, the rotary roll-type cleaning members 12 and 13 are brought into contact with the substrate Wf with the respective contact pressures set on the controller 56. Accordingly, when the contact pressures are to be changed during cleaning of the substrate Wf, for example, the contact pressures of the rotary roll-type cleaning members 12 and 13 can readily be changed by changing the set values on the controller 56.

To perform cleaning in such a manner that the contact pressures of the rotary roll-type cleaning members 12 and 13 vary during cleaning of a single substrate Wf, i.e. from the beginning to the end of the cleaning process, a plurality of programs in which the contact pressures change in different patterns according to the condition of progress of the cleaning process (i.e. the elapse of time) are prepared and stored in a memory of the control unit 55 or the controller 56 in advance. One of the plurality of programs is selected by an operation on the touch panel or the like, which constitutes the controller 56, and the control unit 55 is instructed to execute the selected program. Thus, it becomes easy to clean the substrate Wf with an optimum contact pressure change pattern in conformity to the contaminated condition of the substrate Wf, the kind of cleaning liquid, the temperature condition, and so forth.

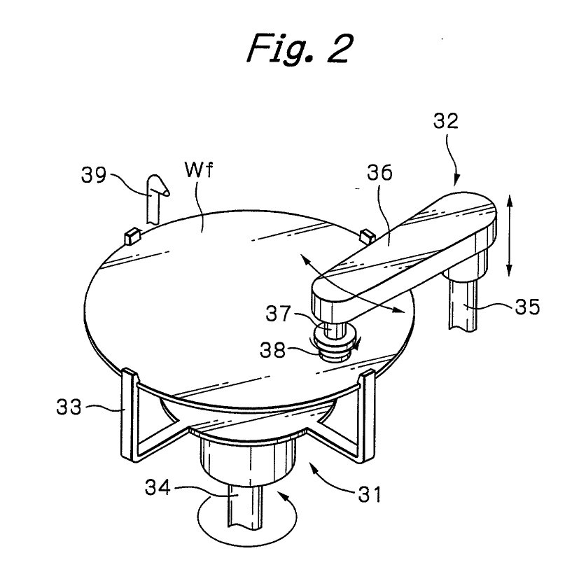

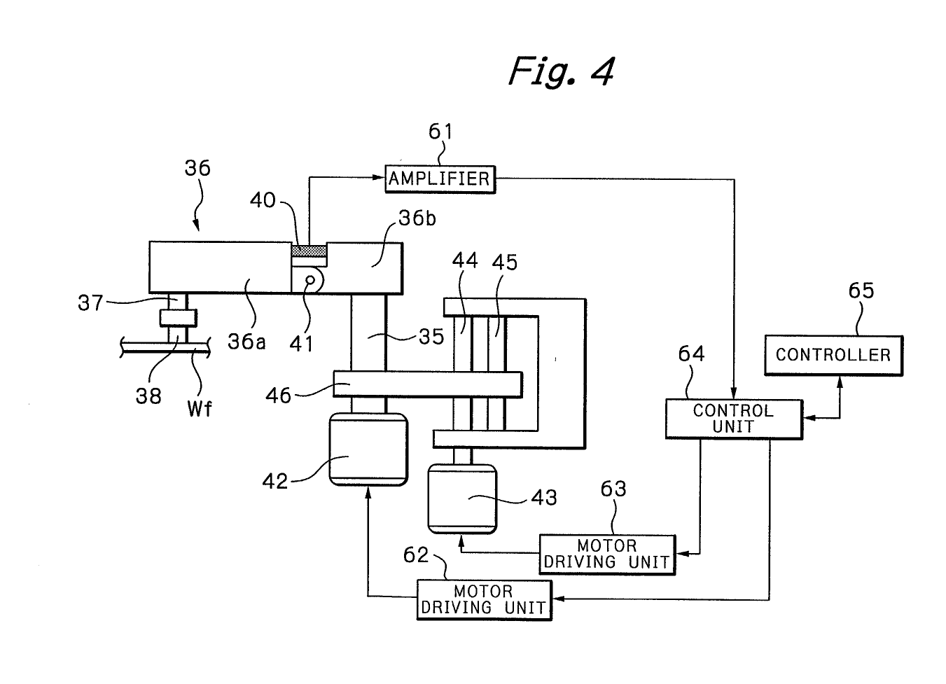

FIG. 4 shows the arrangement of a contact pressure adjusting mechanism and a control system therefor in a substrate cleaning apparatus according to another embodiment of the present invention. The arrangement of the substrate cleaning apparatus using the contact pressure adjusting mechanism and the control system is substantially the same as the arrangement shown in FIG. 2. Therefore, a description of the arrangement is omitted. In FIG. 4, reference numeral 36 denotes a pivoting arm similar to the pivoting arm 36 shown in FIG. 2. The pivoting arm 36 shown in FIG. 4 comprises a front member 36a and a rear member 36b. One end of the front member 36a and one end of the rear member 36b are connected together by a pivot 41. A load cell 40 is provided between the front member 36a and the rear member 36b at the joint therebetween. A rotatively driving shaft 37 is provided at the distal end of the front member 36a of the pivoting arm 36. The rotatively driving shaft 37 projects vertically downward. A pencil-type cleaning member 38 is secured to the lower end of the rotatively driving shaft 37. In other words, the pivoting arm 36 constitutes a cleaning member supporting arm for supporting the pencil-type cleaning member 38. The rear end of the rear member 36b of the pivoting arm 36 is supported by a shaft 35.

The lower end of the shaft 35 is connected to a rotating shaft of a motor 42 for pivoting the pivoting arm 36 under the control of a motor driving unit 62. That is, the pivoting arm 36 is caused to pivot by the motor 42 through the shaft 35. The shaft 35 is rotatably supported by a bracket 46. The bracket 46 is in thread engagement with a ball screw 44. The bracket 46 is vertically movable in response to the rotation of the ball screw 44. The ball screw 44 is connected to a rotating shaft of a motor 43 for vertically moving the pivoting arm 36. Further, the shaft 35 is vertically movable along a linear guide 45.

The load cell 40 can detect stress applied to the pivoting arm 36. That is, when the pencil-type cleaning member 38 presses the substrate Wf, the front member 36a of the pivoting arm 36 is subjected to reaction force such that the front member 36a pivots upward through the pivot 41. Consequently, the load cell 40 receives compressive force corresponding to the reaction force from the front member 36a and the rear member 36b. Thus, the load cell 40 can accurately detect the contact pressure at which the pencil-type cleaning member 38 is brought into contact with the substrate Wf.

The output signal from the load cell 40 is amplified in an amplifier 61 and then transmitted to a control unit 64. The control unit 64 is connected with a controller 65. The controller 65 is formed from a touch panel or the like, which is arranged to allow setting and adjustment of the contact pressure with which the pencil-type cleaning member 38 is brought into contact with the substrate Wf. When the contact pressure of the pencil-type cleaning member 38 is set on the controller 65, the control unit 64 drives the motor 43 through a motor driving unit 63 on the basis of the set value. This causes the ball screw 44 to rotate. Consequently, the pivoting arm 36 moves downward through the bracket 46 and the shaft 35, causing the pencil-type cleaning member 38 to come into contact with the substrate Wf at the set contact pressure.

The contact pressure of the pencil-type cleaning member 38 is detected with the load cell 40. The detected signal is amplified in the amplifier 61 and then transmitted to the control unit 64. The control unit 64 compares the detected contact pressure value with the contact pressure value set on the controller 65 and drives the motor 43 through the motor driving unit 63 so that the difference between the detected and set contact pressure values becomes zero or a predetermined range. Consequently, the pencil-type cleaning member 38 is brought into contact with the substrate Wf with the contact pressure set on the controller 65. Accordingly, when the contact pressure is to be changed during cleaning of the substrate Wf, for example, the contact pressure of the pencil-type cleaning member 38 can readily be changed by changing the set value on the controller 65.

To perform cleaning in such a manner that the contact pressure of the pencil-type cleaning member 38 varies during cleaning of a single substrate Wf, i.e. from the beginning to the end of the cleaning process, a plurality of programs in which the contact pressure changes in different patterns according to the state of progress of the cleaning process (i.e. the elapse of time) are prepared and stored in a memory of the control unit 64 or the controller 65 in advance. One of the plurality of programs is selected by an operation on the touch panel or the like, which constitutes the controller 65, and the control unit 64 is instructed to execute the selected program. Thus, it becomes easy to clean the substrate Wf with an optimum contact pressure change pattern in conformity to the contaminated condition of the substrate Wf, the kind of cleaning liquid, the temperature condition, and so forth.

Although in the foregoing embodiments the present invention has been described with regard to the substrate cleaning apparatus arranged as shown in FIGS. 1 and 2, it should be noted that the present invention is not necessarily limited to these substrate cleaning apparatus. The present invention is applicable to any substrate cleaning apparatus arranged to clean a surface of a substrate with a rotatably supported cleaning member brought into contact with the substrate surface while supplying a cleaning liquid to the substrate surface.

In the foregoing embodiments, the device for detecting the contact pressure of the cleaning member is arranged to detect stress applied to the cleaning member supporting arm, that is, each of the cleaning member supporting arms 17 and 18, or the pivoting arm 36. However, the contact pressure detecting device is not necessarily limited to the described arrangement. Any device capable of detecting the contact pressure of the cleaning member directly or indirectly can be used. Similarly, the arrangement for detecting stress applied to the cleaning member supporting member is not necessarily limited to the described arrangement.

As has been stated above, the present invention provides the following advantageous effects.

According to the present invention, the substrate cleaning apparatus allows the contact pressure to be set and adjusted as desired by controlling the contact pressure adjusting mechanism from the controller. Therefore, the contact pressure can readily be set and adjusted to a pressure suitable for ultraclean substrate surface preparation. Thus, it becomes easy to obtain an ultraclean substrate surface.

The provision of a contact pressure sensor allows the contact pressure to be set and adjusted from the controller while monitoring the actual contact pressure with the contact pressure sensor.

Further, when the substrate cleaning apparatus is provided with a controller that compares the contact pressure value set on the controller with the contact pressure value detected with the contact pressure sensor and effects control so that the difference between the contact pressure values becomes zero or a predetermined range, the contact pressure of the cleaning member can be made to accurately follow the contact pressure set and adjusted on the controller. Accordingly, it becomes possible to obtain an ultraclean substrate surface.

Further, the controller allows the contact pressure to be changed according to the condition of progress of cleaning of the substrate. Accordingly, it is possible to readily and satisfactorily comply with the demand that the ultraclean substrate surface preparation should be performed smoothly.

If the contact pressure sensor is a pressure sensor (e.g. a load cell) for detecting stress applied to the cleaning member supporting arm for supporting the cleaning member, the pressure sensor can be mounted on a predetermined portion of the cleaning member supporting arm of the substrate cleaning apparatus where the pressure sensor will not be contaminated with the cleaning liquid or the like. Accordingly, the contact pressure can be detected with high accuracy, and mounting of the pressure sensor is facilitated.

It should be noted that the present invention is not necessarily limited to the foregoing embodiments but can be modified in a variety of ways.

What is claimed is:

1. A substrate cleaning apparatus arranged to clean a surface of a substrate with a cleaning member brought into contact with said surface while supplying a cleaning liquid to said surface, said apparatus comprising:
a contact pressure adjusting mechanism for adjusting a contact pressure at which said cleaning member is brought into contact with said surface of the substrate; and
a controller for controlling said contact pressure adjusting mechanism;
wherein said contact pressure can be set and adjusted to a predetermined value from said controller.

2. A substrate cleaning apparatus according to claim 1, further comprising:
a contact pressure sensor for detecting said contact pressure.

3. A substrate cleaning apparatus according to claim 2, further comprising:
control means for comparing a contact pressure value set on said controller with a contact pressure value detected with said contact pressure sensor and for effecting control so that a difference between the contact pressure values becomes zero.

4. A substrate cleaning apparatus according to claim 1, 2 or 3, wherein said controller allows said contact pressure to be changed according to a state of progress of cleaning of said substrate.

5. A substrate cleaning apparatus according to any one of claims 2 to 4, wherein said contact pressure sensor is a pressure sensor for detecting said contact pressure by detecting stress applied to a cleaning member supporting arm for supporting said cleaning member.

6. A substrate cleaning apparatus according to claim 2, further comprising:
control means for comparing a contact pressure value set on said controller with a contact pressure value detected with said contact pressure sensor and for effecting control so that a difference between the contact pressure values becomes a predetermined rage.
